(19) United States
(12) Patent Application Publication
(10) Pub. No.: US 2014/0315566 A1
(43) Pub. Date: Oct. 23, 2014

(54) METHOD AND APPARATUS FOR CONTROLLING INTERFERENCE IN WI-FI-INTEGRATED SMALL CELL ENVIRONMENT

(71) Applicant: Electronics and Telecommunications Research Institute, Daejeon-si (KR)

(72) Inventors: Seung Que LEE, Daejeon-si (KR); Sang Chul OH, Daejeon-si (KR); Kyung Sook KIM, Daejeon-si (KR); Sung Hyun MOON, Seoul (KR); Byung Han RYU, Daejeon-si (KR); Nam Hoon PARK, Daejeon-si (KR)

(73) Assignee: Electronics and Telecommunications Research Institute, Daejeon-si (KR)

(21) Appl. No.: 14/083,953

(22) Filed: Nov. 19, 2013

(30) Foreign Application Priority Data
Apr. 19, 2013 (KR) 10-2013-0043317

(51) Int. Cl. H04W 72/08

(52) U.S. Cl. CPC H04W 72/082
USPC 455/452.2

(57) ABSTRACT

Provided are a method and apparatus for controlling inter-cell interference. In accordance with the present invention, a Wi-Fi signal including interference control information is received from a neighboring cell, the interference control information is transmitted to a small cell transmission/reception module, and a small cell signal is transmitted or received by controlling inter-cell interference based on the interference control information.

This application claims priority to Korean patent application number 10-2013-0043317 filed on Apr. 19, 2013, the entire disclosure of which is incorporated by reference herein.

### BACKGROUND OF THE INVENTION

1. Field of the Invention

The present invention relates to wireless communication and, more particularly, to a method and apparatus for controlling inter-cell interference in a Wi-Fi-integrated small cell environment in which Wi-Fi and a small cell operate at the same time.

2. Discussion of the Related Art

Wi-Fi is a system for wirelessly expanding a Local Area Network (LAN) and a system in which a wireless access point is connected to a wired Internet so that a user terminal can use the Internet wirelessly. Wi-Fi is an efficient method that is simple in structure and cheap in a communication cost and is prepared for an increase of mobile traffic.

A small cell refers to an environment in which the size of a cell operated by one base station is about 10 to 20 m in a mobile communication system. The small cell is installed at home or in a building. As a result of examples of mobile communication users examined, about 70% of all the mobile communication users perform communication indoors. When this fact is taken into consideration, a small cell environment can be said to be one of methods based on the next-generation mobile communication infrastructure which can minimize a reduction in wireless resource spectrum efficiency due to a wall loss.

A representative example of a small cell is a femto cell. A femto cell is a mobile communication system configured to include a small-sized mobile communication base station and low cell output and to operate at home. In general, the backhaul of a fixed type femto cell consists of a broadband Internet network, and the femto cell accesses the core network of a mobile communication system over the broadband Internet network.

Wi-Fi is simple and cheap in a communication cost, but in Wi-Fi, it is difficult to perform billing or quality of service because session management is difficult every user. In contrast, session management for each user or handover is possible in a small cell, a network configuration is complicated and a communication cost is relatively high. Wi-Fi and a small cell have the support of wireless network offloading for solving the overload of mobile traffic in common. The characteristics of Wi-Fi and a small cell can be utilized to a maximum extent and disadvantages of Wi-Fi and the small cell can be supplemented by mixing Wi-Fi and the small cell.

Inter-cell interference control refers to control technology in which inter-frequency interference generated when cells use the same frequency resources is avoided or minimized. In a hierarchical cell environment or a cell environment including many neighboring cells, such as a small cell environment, inter-cell interference control technology is an important technique to determine the performance of a cell.

In general, inter-cell interference is solved within a range of the infrastructure of a small cell. For example, neighboring small cell base stations can control the use of radio resources by obtaining information related to the radio resources of a counterpart base station (e.g., scheduling information and RF output information) through the periodic exchange of pieces of information. The exchange of pieces of information may be performed according to a distributed control method in which small cell base stations autonomously exchange pieces of information and make determinations or may be performed according to a centralized control method in which a server is placed at the center, small cell base stations exchange pieces of information through the medium of the server, and control is performed by the server.

Furthermore, a method of exchanging pieces of information includes a method of a base station performing communication over a wired network and a method of an additional receiver within a small cell base station performing communication by directly receiving radio signals from neighboring base stations. In the method using a wired network, it is very difficult to set up and manage a link for exchanging pieces of information when there are many small cell base stations. In the method of receiving a radio signal, an additional and expensive small cell reception module must be used.

That is, if inter-cell interference control is solved within small cell technology and related infrastructure in a small cell environment, there are problems in that the complexity of a link for setup and maintenance between base stations is increased and an additional and expensive small cell reception module for receiving a mobile communication signal must be used.

Accordingly, the present invention proposes a method of simply controlling interference between small cells with low cost through the cooperation of Wi-Fi in a communication environment in which Wi-Fi and a small cell are integrally operated.

### SUMMARY OF THE INVENTION

An object of the present invention is to provide a method and apparatus for controlling interference in a Wi-Fi-integrated small cell environment.

In accordance with an aspect of the present invention, a base station includes a Wi-Fi reception module configured to receive a Wi-Fi signal, including interference control information, from a neighboring cell and transfer the interference control information to a small cell transmission/reception module, and the small cell transmission/reception module configured to transmit or receive a small cell signal by controlling inter-cell interference based on the interference control information.

In accordance with another aspect of the present invention, a base station includes a Wi-Fi transmission/reception module configured to receive a Wi-Fi signal, including interference control information, from a neighboring cell and to transfer the interference control information to a small cell transmission/reception module or transmit a Wi-Fi signal by controlling inter-cell interference based on the interference control information, and the small cell transmission/reception module configured to transmit or receive a small cell signal by controlling inter-cell interference based on the interference control information.

In accordance with yet another aspect of the present invention, a method of a base station controlling inter-cell interference includes receiving a Wi-Fi signal, including interference control information, from a neighboring cell and transmitting or receiving a small cell signal by controlling inter-cell interference based on the interference control information.

### BRIEF DESCRIPTION OF THE DRAWINGS

FIG. 1 shows an example of a BS for transmitting and receiving pieces of interference control information in a Wi-Fi-integrated small cell communication environment;

FIG. 2 shows an example of a Wi-Fi-integrated small cell BS for transmitting and receiving signals in accordance with the present invention;

FIG. 3 shows another example of a Wi-Fi-integrated small cell BS for transmitting and receiving signals in accordance with the present invention; and

FIG. 4 is a flowchart illustrating an example of a method of the Wi-Fi-integrated small cell BS transmitting and receiving pieces of interference control in a Wi-Fi-integrated small cell communication environment in accordance with the present invention.

### DETAILED DESCRIPTION OF THE EMBODIMENTS

Hereinafter, embodiments of the present invention will be described in detail with reference to the accompanying drawings so that they can be readily implemented by those skilled in the art.

Hereinafter, some embodiments of the present invention are described in detail with reference to the accompanying drawings in order for a person having ordinary skill in the art to which the present invention pertains to be able to readily implement the invention. It is to be noted the present invention may be implemented in various ways and is not limited to the following embodiments. Furthermore, in the drawings, parts not related to the present invention are omitted in order to clarify the present invention and the same or similar reference numerals are used to denote the same or similar elements.

The objects and effects of the present invention can be naturally understood or will become clear by the following description, and the objects and effects of the present invention are not restricted by the following description only.

The objects, characteristics, and merits will become more apparent from the following detailed description. Furthermore, in describing the present invention, a detailed description of a known art related to the present invention will be omitted if it is deemed to make the gist of the present invention unnecessarily vague. A preferred embodiment in accordance with the present invention is described in detail below with reference to the accompanying drawings.

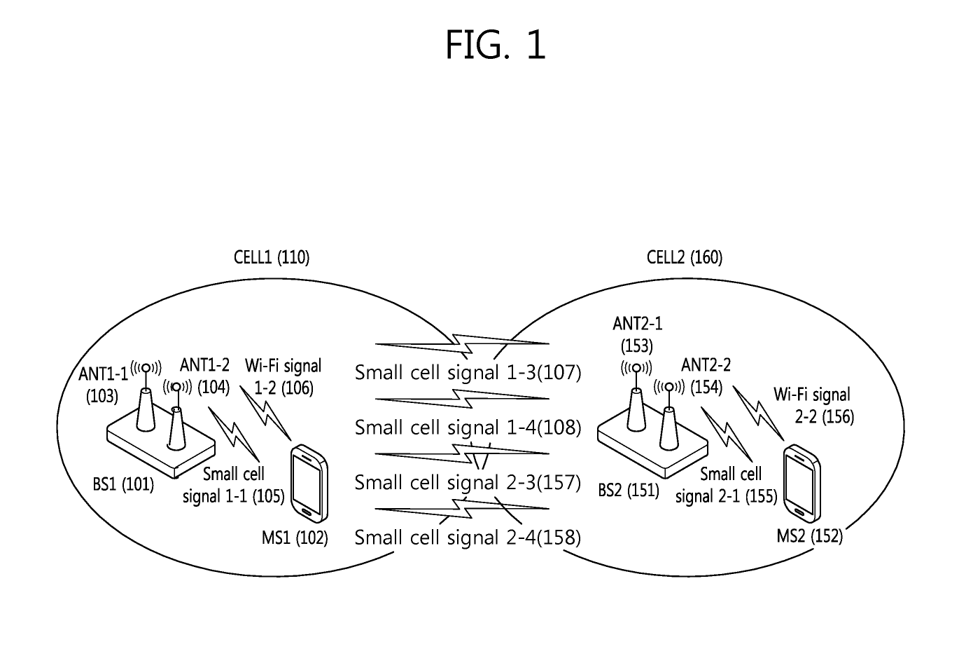

FIG. 1 shows an example of a Base Station (BS) for transmitting and receiving pieces of interference control information in a Wi-Fi-integrated small cell communication environment. The example shows the transmission and reception of signals between a first cell (CELL1) 110 and a second cell (CELL2) 160.

Referring to FIG. 1, a first BS (BS1) 101 and a second BS (BS2) 151 are Wi-Fi-integrated small cell BSs which process neighboring cells.

The BS1 includes a (1-1)^{th} antenna (ANT1-1)103 in order to transmit and receive small cell signals and a (1-2)^{th} antenna (ANT1-2)104 in order to transmit and receive Wi-Fi signals.

The BS2 includes a (2-1)^{th} antenna (ANT2-1) 153 in order to transmit and receive small cell signals and a (2-2)^{th} antenna (ANT2-2) 154 in order to transmit and receive Wi-Fi signals.

The first Mobile Station (MS1) 102 transmits and receives a small cell signal1-1 105 and a Wi-Fi signal1-2 106 through the BS1 101.

The second Mobile Station (MS2) 152 transmits and receives a small cell signal2-1 155 and a Wi-Fi signal2-2 156 through the BS2 151.

Furthermore, inter-cell interference signals between the CELL1 110 and the CELL2 160 include a small cell signal1-3 107 and a Wi-Fi signal1-4 108 due to the signal of the BS1 101 which gets out of the first cell 110 and affects the second cell 160 and a small cell signal2-3 157 and a Wi-Fi signal2-4 158 due to the signal of the BS2 151 which gets out of the second cell 160 and affects the first cell 110.

Since different channels are used between neighboring cells in Wi-Fi, the Wi-Fi signal1-4 108 and the Wi-Fi signal2-4 158 do not act on a neighboring BS as an interference factor.

In a small cell, however, the small cell signal1-3 107 and the small cell signal2-3 157 may use the same channel. Accordingly, if a collision occurs between subchannels within a channel, the collision acts on a counterpart as an interference factor.

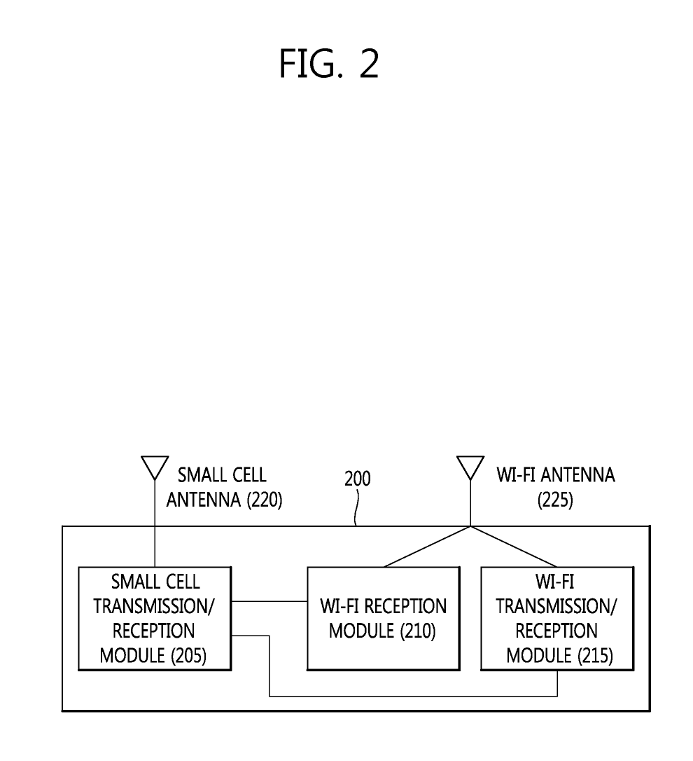

FIG. 2 shows an example of a Wi-Fi-integrated small cell BS 200 for transmitting and receiving signals in accordance with the present invention.

Referring to FIG. 2, the BS 200 includes at least one of a small cell transmission/reception module 205, a Wi-Fi reception module 210, a Wi-Fi transmission/reception module 215, a small cell antenna 220, and a Wi-Fi antenna 225.

The small cell transmission/reception module 205 transmits and receives small cell signals through the small cell antenna 210.

The Wi-Fi transmission/reception module 215 transmits and receives Wi-Fi signals through the Wi-Fi antenna 225.

The Wi-Fi transmission/reception module 215 transmits interference control information about a small cell through a Wi-Fi signal. That is, the Wi-Fi transmission/reception module 215 includes the interference control information about a small cell in the Wi-Fi signal and sends the Wi-Fi signal. The Wi-Fi signal including the interference control information may be received by a neighboring BS and used to control interference due to a small cell signal from the neighboring BS.

Here, the interference control information can include subchannel scheduling information or RF output information.

The Wi-Fi reception module 210 receives a Wi-Fi signal transmitted by a neighboring cell and transfers interference control information about the neighboring cell to the small cell transmission/reception module 205.

The small cell transmission/reception module 205 uses the interference control information about the neighboring BS to control its small cell interference.

In accordance with the present invention, neighboring BSs obtain pieces of information about radio resources used by counterpart BSs, giving interference each other, through respective Wi-Fi reception devices. Accordingly, each BS can take a radio resource policy suitable for the BS by taking the pieces of information about radio resources into consideration.

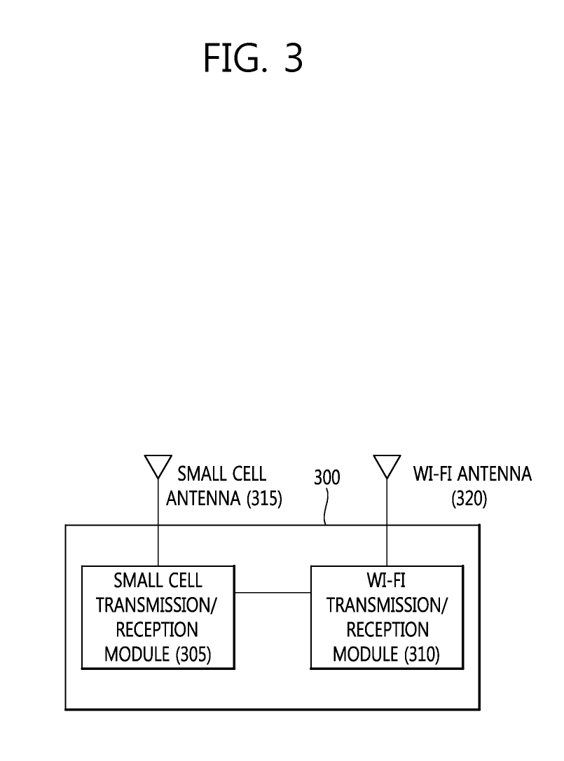

FIG. 3 shows another example of a Wi-Fi-integrated small cell BS 300 for transmitting and receiving signals in accordance with the present invention.

Referring to FIG. 3, the BS 300 includes at least one of a small cell transmission/reception module 305, a Wi-Fi transmission/reception module 310, a small cell antenna 315, and a Wi-Fi antenna 320. The BS 300 does not include an additional Wi-Fi reception module.

The Wi-Fi transmission/reception module 310 transmits and receives its own Wi-Fi signals and receives Wi-Fi signals from neighboring BSs. Here, in order for one module to receive two signals having different channels, a sharing method, such as time division or frequency division, can be used.

The small cell transmission/reception module 305 transmits and receives small cell signals through the small cell antenna 315, and the Wi-Fi transmission/reception module 310 transmits and receives Wi-Fi signals through the Wi-Fi antenna 320.

Interference control information about a small cell can be transferred to the Wi-Fi transmission/reception module 310, included in a Wi-Fi signal, and then transmitted. Here, the interference control information can be subchannel scheduling information or RF output information.

The Wi-Fi transmission/reception module 310 receives a Wi-Fi signal from a neighboring cell and transfers interference control information about the neighboring cell to the small cell transmission/reception module 305.

The small cell transmission/reception module 305 uses the received interference control information about the neighboring BS to control its small cell interference.

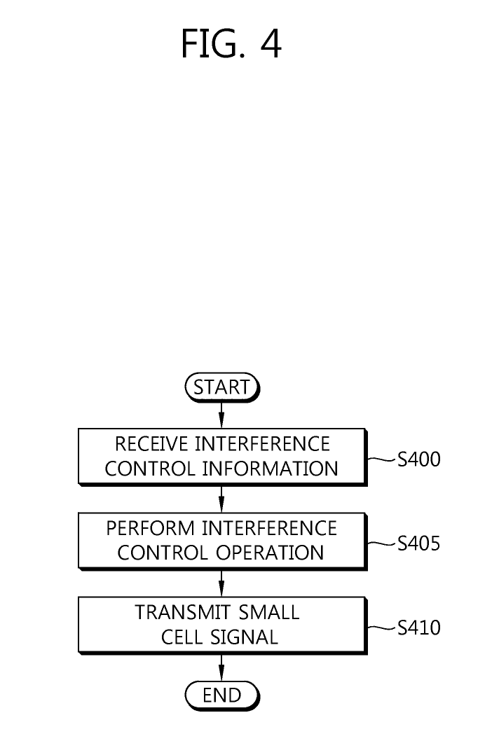

FIG. 4 is a flowchart illustrating an example of a method of the Wi-Fi-integrated small cell BS transmitting and receiving pieces of interference control in a Wi-Fi-integrated small cell communication environment in accordance with the present invention.

Referring to FIG. 4, the BS receives a Wi-Fi signal, including interference control information, from a BS2 through the Wi-Fi transmission/reception module or the Wi-Fi reception module at step S400. Here, a sharing method, such as time division or frequency division, can be used in order for one module to receive two signals having different channels.

The interference control information can be subchannel scheduling information or RF output information.

The BS performs an operation of controlling interference based on the interference control information at step S405.

Next, the BS sends a small cell signal to the BS2, another BS, or another MS at step S410. The BS sends the small cell signal through the small cell transmission/reception module or the small cell antenna.

In accordance with the present invention, in a Wi-Fi-integrated small cell environment, interference can be simply controlled without the exchange of pieces of information over a wired network between BSs or an expensive and additional small cell reception module.

A person having ordinary skill in the art to which the present invention pertains may substitute, modify and change the present invention in various ways without departing from the technical spirit of the present invention. Accordingly, the present invention is not limited to the aforementioned embodiments and the accompanying drawings.

In the above exemplary system, although the methods have been described based on the flowcharts in the form of a series of steps or blocks, the present invention is not limited to the sequence of the steps, and some of the steps may be performed in a different order from that of other steps or may be performed simultaneous to other steps. Furthermore, those skilled in the art will understand that the steps shown in the flowchart are not exclusive and the steps may include additional steps or that one or more steps in the flowchart may be deleted without affecting the scope of the present invention.

What is claimed is:

1. A base station, comprising:
a Wi-Fi reception module configured to receive a Wi-Fi signal, comprising interference control information, from a neighboring cell and transfer the interference control information to a small cell transmission/reception module; and
the small cell transmission/reception module configured to transmit or receive a small cell signal by controlling inter-cell interference based on the interference control information.

2. The base station of claim 1, further comprising a Wi-Fi transmission/reception module configured to transmit or receive a Wi-Fi signal by controlling inter-cell interference based on the interference control information.

3. The base station of claim 2, wherein the interference control information comprises subchannel scheduling information or radio frequency output information.

4. The base station of claim 2, wherein the interference control information comprises information about radio resources used by the neighboring cell.

5. The base station of claim 2, wherein the small cell transmission/reception module or the Wi-Fi transmission/reception module uses a time division or frequency division sharing method.

6. The base station of claim 1, wherein the small cell transmission/reception module controls a radio resource use policy based on the interference control information.

7. A base station, comprising:
a Wi-Fi transmission/reception module configured to receive a Wi-Fi signal, comprising interference control information, from a neighboring cell and to transfer the interference control information to a small cell transmission/reception module or transmit a Wi-Fi signal by controlling inter-cell interference based on the interference control information; and
the small cell transmission/reception module configured to transmit or receive a small cell signal by controlling inter-cell interference based on the interference control information.

8. The base station of claim 7, wherein the interference control information comprises subchannel scheduling information or radio frequency output information.

9. The base station of claim 7, wherein the interference control information comprises information about radio resources used by the neighboring cell.

10. The base station of claim 7, wherein the small cell transmission/reception module or the Wi-Fi transmission/reception module uses a time division or frequency division sharing method.

11. The base station of claim 7, wherein the small cell transmission/reception module controls a radio resource policy based on the interference control information.

12. A method of a base station controlling inter-cell interference, comprising:
receiving a Wi-Fi signal, comprising interference control information, from a neighboring cell; and
transmitting or receiving a small cell signal by controlling inter-cell interference based on the interference control information.

13. The method of claim 12, further comprising transmitting or receiving the Wi-Fi signal by controlling inter-cell interference based on the interference control information.

14. The method of claim 12, wherein the interference control information comprises subchannel scheduling information or radio frequency output information.

15. The method of claim 12, wherein the interference control information comprises information about radio resources used by the neighboring cell.

16. The method of claim 13, wherein the Wi-Fi signal or the small cell signal is transmitted or received using a time division or frequency division sharing method.

17. The method of claim 12, further comprising controlling a radio resource use policy based on the interference control information.
